(19) United States
(12) Patent Application Publication
(10) Pub. No.: US 2008/0169240 A1
(43) Pub. Date: Jul. 17, 2008

(54) Arsenic Removal

(75) Inventors: Spiro Alexandratos, Glen Ridge, NJ (US); Richard F. Salinaro, Hastings on Hudson, NY (US); Laurent Dambies, Newcastle Upon Tyne (GB)

Correspondence Address: LEYDIG VOIT & MAYER, LTD, 700 THIRTEENTH ST. NW, SUITE 300, WASHINGTON, DC, 20005-3960, US

(73) Assignee: The Research Foundation of the City University of New York, New York, NY (US)

(21) Appl. No.: 10/568,542

(22) PCT Filed: Sep. 7, 2004
(86) PCT No.: PCT/US04/28977

§ 371 Date: Feb. 28, 2007

(51) Int. Cl. B01D 15/04; C08F 8/32; C02F 1/42

(52) U.S. Cl. 210/665; 525/331.4; 525/330.5; 525/55; 210/263

(57) ABSTRACT

Crosslinked polymeric beads for removing arsenate from water, as well as methods for preparing and using the beads are disclosed.

### CROSS-REFERENCE TO RELATED PATENT APPLICATIONS

This patent application claims the benefit of U.S. Provisional Patent Application No. 60/500,259, filed Sep. 5, 2003, which is incorporated by reference.

### FIELD OF THE INVENTION

This invention pertains to polymer beads for removing arsenic from aqueous fluids such as groundwater.

### BACKGROUND OF THE INVENTION

Arsenic is a toxic and ubiquitous metalloid element that can be found in groundwaters around the world at levels well above the maximum containment level of 10 μg/L recommended by the World Health Organization (WHO). Arsenic poses a serious threat to millions of people worldwide, and geogenic (natural) contamination has been reported in many countries, including countries having large populations such as India and China. In the U.S., the Environmental Protection Agency (EPA) has recently decreased the limit of arsenic in drinking water from 50 μg/L to 10 μg/L, and all systems for treating drinking water must comply with the new standard by January 2006.

Arsenic occurs mainly as arsenate As(V) (having a +5 oxidation state) and arsenite As(III) (having a +3 oxidation state) in groundwaters. Different compounds can be formed with arsenic in groundwater depending on the arsenic oxidation state. The distribution of As(III)/As(V) varies significantly in groundwater. As(III) can represent in the range of about 30% to about 98% of the total arsenic in groundwaters.

Conventional systems for removing arsenic have suffered from a number of drawbacks such as low efficiency and/or specificity. For example, some ion exchange systems have less affinity for As(V), particularly when other ions (e.g., sulfate, chloride, and/or phosphate ions) are present in the fluid being treated. Typically, As(III) is pre-oxidized to As(V) so that the oxidized form can subsequently be removed.

Alternatively, or additionally, some ion exchange systems require regeneration after a relatively short period of time. For example, Clifford has estimated bed volumes for 10 percent and 50 percent breakthrough of influent arsenic (FIG. 3-15, J. AWWA, 86:4:10 (1995)), showing the regeneration frequencies for ion exchange columns as a function of influent sulfate concentration. Regeneration can involve using brine solution, and this creates another arsenic-containing waste stream that must also be processed. While brine solutions can be re-used, the resultant arsenic concentration can exceed the technology based local limits (TBLL), and the spent solution must be treated and/or disposed of.

The present invention provides for ameliorating at least some of the disadvantages of the prior art. These and other advantages of the present invention will be apparent from the description as set forth below.

### BRIEF SUMMARY OF THE INVENTION

An embodiment of the invention provides a chelate-forming material comprising a crosslinked polymeric bead having bound chelate-forming groups and a volume capacity of about 1.5 mmol/mL or less, wherein the chelate-forming groups comprise protonated N-methyl-D-glucamine, and have the capability of forming a chelate with As(V) and/or compounds thereof.

Alternatively, or additionally, another embodiment of the invention provides a chelate-forming material comprising a crosslinked polymeric bead having bound chelate-forming groups and a nitrogen content of about 2.4 mmol/g or more, wherein the chelate-forming groups comprise protonated N-methyl-D-glucamine, and have the capability of forming a chelate with As(V) and/or compounds thereof.

In some embodiments, the protonated N-methyl-D-glucamine is in chloride form, or in sulfate form.

An embodiment of a method for treating an arsenic-containing aqueous fluid according to the invention comprises contacting an As(V)-containing fluid with crosslinked polymeric beads each having bound chelate-forming groups and a volume capacity of about 1.5 mmol/mL or less, wherein the chelate-forming groups comprise protonated N-methyl-D-glucamine and have the capability of forming a chelate with arsenate(V) and/or compounds thereof, forming the chelate with As(V) and/or a compound thereof, and separating the chelated As(V) and/or compound thereof from the fluid.

Yet another embodiment of a method for treating an arsenic-containing aqueous fluid according to the invention comprises contacting an As(V)-containing fluid with crosslinked polymeric beads each having bound chelate-forming groups and a nitrogen content of about 2.4 mmol/g or more, wherein the chelate-forming groups comprise protonated N-methyl-D-glucamine and have the capability of forming a chelate with arsenic(V) and/or compounds thereof, forming the chelate with As(V) and/or a compound thereof, and separating the chelated As(V) and/or compound thereof from the fluid.

In another embodiment, a process for preparing a chelate-forming crosslinked polymeric bead having a volume capacity of about 1.5 mmol/mL or less and/or a nitrogen content of about 2.4 mmol/g or more, wherein the bead is comprised of a crosslinked polymer bound to chelate-forming groups, comprises obtaining a crosslinked polymeric bead having functional groups, reacting the functional groups with N-methyl-D-glucamine, and producing a protonated N-methyl-D-glucamine.

### DETAILED DESCRIPTION OF THE INVENTION

An embodiment of the invention provides a crosslinked polymeric bead having bound chelate-forming groups and a volume capacity of about 1.5 mmol/mL or less, wherein the chelate-forming groups comprise protonated N-methyl-D-glucamine, and have the capability of forming a chelate with As(V) and/or compounds thereof. In a preferred embodiment, the bead has a volume capacity of about 1.3 mmol/mL or less.

Alternatively, or additionally, another embodiment of the invention provides a crosslinked polymeric bead having bound chelate-forming groups and a nitrogen content by dry weight basis of about 2.4 mmol/g or more, wherein the chelate-forming groups comprise protonated N-methyl-D-glucamine, and have the capability of forming a chelate with As(V) and/or compounds thereof. In a preferred embodiment, the bead has a nitrogen content by dry weight basis of about 2.5 mmol/g or more.

In some embodiments of crosslinked beads according to the invention, the protonated N-methyl-D-glucamine is in chloride form, or sulfate form.

In an embodiment, the crosslinked polymeric bead comprises poly(vinylbenzylchloride) or chloromethylated styrene wherein the chelate-forming groups are bound to at least a portion of the —CH₂ groups of the benzyl moieties. In another embodiment, the crosslinked polymeric bead comprises poly(glycidyl methacrylate) wherein the chelate forming groups are bound to at least a portion of the glycidal groups of the acrylate moieties.

In some embodiments, the crosslinked polymeric bead comprises a polymerized bi-, tri-, or tetra-functional monomer, or any combination thereof, to provide the crosslinks. The bi-, tri-, or tetra-functional monomer can be selected from the group consisting of ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, butanediol diacrylate, hexanediol diacrylate, N,N-methylenebisacrylamide, N,N-(1,2-dihydroxyethylene) bisacrylamide, and divinylbenzene, or any combination thereof.

A system for treating arsenic-containing aqueous fluid according to an embodiment of the invention comprises a bed comprising crosslinked polymeric beads each bead having bound chelate-forming groups, and a volume capacity of about 1.5 mmol/mL or less and/or a nitrogen content by dry weight basis of about 2.4 mmol/g, wherein the chelate-forming groups comprise protonated N-methyl-D-glucamine, and have the capability of forming a chelate with As(V) and/or compounds thereof.

An embodiment of a method for treating an arsenic-containing aqueous fluid according to the invention comprises contacting an As(V)-containing fluid with crosslinked polymeric beads, each bead having bound chelate-forming groups, and a volume capacity of about 1.5 mmol/mL or less and/or a nitrogen content by dry weight basis of about 2.4 mmol/g or more, wherein the chelate-forming groups comprise protonated N-methyl-D-glucamine, and having the capability of forming a chelate with arsenic(V) and/or compounds thereof, forming the chelate with As(V) and/or a compound thereof, and separating the chelated As(V) or compound thereof from the fluid. A preferred embodiment of the invention comprises separating As(V) from groundwater.

In another embodiment, a process for preparing a chelate-forming crosslinked polymeric bead having a volume capacity of about 1.5 mmol/mL or less and/or a nitrogen content of about 2.4 mmol/g or more, wherein the bead is comprised of a crosslinked polymer bound to chelate-forming groups, comprises obtaining a crosslinked polymeric bead having functional groups, reacting the functional groups with N-methyl-D-glucamine, and producing a protonated N-methyl-D-glucamine. In some embodiment of the process, the crosslinked polymeric bead having functional groups comprises a poly(vinylbenzylchloride) bead, a chloromethylated polystyrene bead, or a poly(glycidyl methacrylate) bead. The functional groups on the crosslinked polymer bead can be haloalkyl groups or epoxy groups.

The present invention is preferably used to treat source water, such as municipal drinking water, water from natural sources such as lakes, rivers, reservoirs, surface water, groundwater and storm water runoff, or industrial source water, or wastewater, such as industrial wastewater or municipal wastewater. Source water may also include treated wastewater which has, for example, been purified after industrial use.

Embodiments of the invention can also be used to treat As(V)-containing brine.

Advantageously, in view of the affinity, selectivity, and sorption capacities of the beads according to the invention, beds including the beads can be used to treat greater volumes of water and/or treat the water for longer periods of time, before replacement and/or regeneration, than beds including conventionally available beads. Additionally, since the beds can be used for longer periods of time before regeneration, less regeneration treatment fluid is needed for a given period of time and/or there is less process downtime for the beds, compared to that for beds including conventionally available beads.

The invention provides for the removal of As(V) from influent aqueous fluids, typically source water having a pH in the range of from about 1 to about 11, preferably, having a pH in the range of from about 4 to about 6.5. As used herein, removal of As(V) includes removal of the arsenic-containing negatively charged compounds typically formed in natural waters at a pH in the range of 2 to 11, i.e., H₂AsO₄⁻¹ and HAsO₄⁻². In some embodiments, the invention provides for the removal of the arsenic-containing uncharged compound, H₃AsO₂, formed in aqueous fluids at a pH of about 1 to about 1.5.

Embodiments of the invention can efficiently remove As(V) from groundwater having a sulfate concentration of greater than 120 mg/T, e.g., up to about 800 mg/L, or more and/or can efficiently remove As(V) from groundwater having a phosphate concentration of up to about 400 mg/L, or more. Alternatively, or additionally, embodiments of the invention can remove As(V) from aqueous fluids in the presence of 1M NaCl.

The chelate-forming groups of the present invention comprise protonated N-methyl-D-glucamine represented by formula (I):

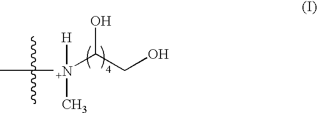

The chelate-forming group, N-methyl-D-glucamine (NMDG), can be quantified by a variety of techniques, including elemental analysis. Elemental analysis is performed to determine the amount of nitrogen, or equivalents of nitrogen, present in the chelate-forming group. Since the chelate-forming group is the sole group that contains nitrogen, the equivalents of nitrogen are directly related to the equivalents of the chelate-forming group present on the bead. This can be further defined as “theoretical specific capacity”, (IUPAC Compendium of Analytical Nomenclature, section 9.2.5.4, 1997, 3rd ed.) which is the amount (mmol) of ionogenic group per mass (g) of dry ion exchanger.

Illustrative elemental analytical techniques for determining the nitrogen content of beads according to the invention are ASTM D 5373 (2002) “Test Methods for Instrumental Determination of Carbon, Hydrogen, and Nitrogen in Laboratory Samples of Coal and Coke” and ASTM D 5291 (2003) “Test Method for Instrumental Determination of Carbon, Hydrogen, and Nitrogen in Petroleum Products and Lubricants.”

For example, when analyzed in accordance with ASTM D 5373, crosslinked beads according to embodiments of the invention, comprising the protonated N-methyl-D-glucamine, have a nitrogen content, or a dry weight basis, of 2.35 mmol/g or more. Typically, when analyzed in accordance with ASTM D 5373, crosslinked beads according to embodiments of the invention have a nitrogen content, on a dry weight basis, of 2.46 mmol/g or more.

In accordance with some embodiments of the invention, the crosslinked bead comprising the protonated N-methyl-D-glucamine, has a nitrogen content, on a dry weight basis, of about 2.4 mmol/g or more, preferably, a nitrogen content of about 2.5 mmol/g or more, more preferably, a nitrogen content of about 2.6 mmol/g or more, and in some embodiments, a nitrogen content of about 2.7 mmol/g or more.

In accordance with the invention, the bead (or particle) is preferably a non-porous bead, although it may have pores having diameters of 50 Angstroms or less, e.g., micropores. The bead is crosslinked. Preferred crosslinked polymeric beads comprise poly(vinylbenzylchloride) copolymer beads and poly(glycidyl methacrylate) copolymer beads. Other embodiments include, for example, crosslinked chloromethylated polystyrene copolymer beads, and crosslinked polymer beads functionalized with amine reactive chemistries such as epichlorohydrin and azlactone.

In some embodiments, the crosslinked polymeric bead comprises a polymerized bi-, tri-, or tetra-functional monomer, or any combination thereof, to provide the crosslinks. The bi-, tri-, or tetra-functional monomer can be selected from the group consisting of ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, butanediol diacrylate, hexanediol diacrylate, N,N-methylenebisacrylamide, N,N-(1,2-dihydroxyethylene) bisacrylamide, and divinylbenzene (DVB), or any combination thereof.

A variety of crosslinkers can be used in preparing beads according to the invention. Preferred crosslinking agents include compounds with two or more groups. Exemplary crosslinkers include ethylene glycol di(meth)acrylate (EGDMA), ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate; butanediol diacrylate, hexanediol diacrylate, methylenebisacrylamide, N,N methylenebisacrylamide, N,N-(1,2-dihydroxyethylene)bisacrylamide), and divinylbenzene (DVB).

The degree of crosslinking is preferably about 7% or less, more preferably, about 5% or less, and in some embodiments, about 3% or less. The desired range can be varied depending on, for example, the hydrophilicity of the backbone polymer and the structure of the crosslinking agent. Illustratively, the degree of crosslinking can be in the range of from about 2% to about 7% (e.g., wherein the bead includes a more hydrophilic backbone polymer such as, for example, poly(glycidyl methacrylate)), or from about 2% to about 5% (e.g., wherein the bead includes a more hydrophobic backbone polymer, such as, for example, poly(vinylbenzylchloride) or chloromethylated polystyrene).

Without being limited to any particular mechanism(s), it is believed the polymer chains (e.g., polystyrene backbone) forming the bead are flexible, and this flexibility, and the level of crosslinking are important, so that the lower level of crosslinking (about 7% or less) allows increased swelling of the bead, allowing more reactive groups to bind NMDG to the bead, providing more available surface area allowing a greater amount of the NMDG to be bound to the bead, and allowing more of the protonated NMDG to be accessed by the As(V) in the fluid to be treated. As a result, more of the protonated NMDG is available for selectively forming a chelate with the As(V) and/or compounds thereof.

In some embodiments of the invention, the crosslinked polymeric bead having bound chelate-forming groups has volume capacity of about 1.5 mmol/mL or less, preferably, about 1.3 or less. In some embodiments, the volume capacity is in the range of from about 1.5 mmol/mL to about 1.1 mmol/mL. Without being bound to any particular mechanism, it is believed the volume capacity can be generally correlated with the degree of crosslinking.

As used herein, the volume capacity is, as defined in IUPAC Compendium of Analytical Nomenclature, section 9.2.5.4, 1997, 3rd ed., the amount (mmol) of ionogenic group per volume (cm³) of swollen ion exchanger. The ionic form of the ion exchanger and the medium should be stated. In accordance with the present invention, the ionic form of the ion exchanger is the protonated amine, and the medium is water.

In an embodiment of the invention, the swelling ratio is about 1.5 or more, preferably about 2.3 or more. Typically, the swelling ratio is in the range of from about 1.5 to about 2.5, and in some embodiments, can be greater than about 2.5.

As used herein, the swelling ratio refers to the increase in volume when comparing the volume of the beads after a specified time in water to the volume of vacuum dried beads. The specific swelling ratios referenced in the Examples section herein were determined using 2 mL of vacuum dried beads that were placed in a 10 mL cylinder of water, wherein the volume was determined after 19 hours.

In accordance with the invention, the process for preparing a chelate-forming crosslinked polymeric bead comprises obtaining a crosslinked polymeric bead having funnctional groups, and reacting these functional groups with NMDG to bind the NMDG to the crosslinked bead. Preferred functional groups are haloalkyl groups, i.e., chloromethyl, or epoxy groups. In those embodiments wherein the crosslinked polymeric bead comprises poly(vinylbenzylchloride) or chloromethylated polystyrene, the reactive functional groups are chloromethyl groups, and the NMDG becomes bonded to the —CH₂ groups of the benzyl moieties via a nucleophilic substitution reaction at the chloromethyl group. In those embodiments wherein the crosslinked polymeric bead comprises poly(glycidyl methacrylate) or epichlorohydrin, the reactive functional groups are epoxy groups, and the N-methyl-D-glucamine becomes bonded to the glycidal groups of the acrylate moieties via a ring-opening reaction of an epoxy group.

The resulting bead is conditioned with a dilute acidic solution such as, for example, HCl or H₂SO₄, to produce a protonated amine moiety on the chelate-forming group. For example, the bead can be conditioned with HCl to provide protonated N-methyl-D-glucamine in chloride form, or conditioned with H₂SO₄ to provide protonated N-methyl-D-glucamine in sulfate form. If desired, one form can be exchanged to the other, e.g., the sulfate form can be exchanged to the chloride form, or the chloride form can be exchanged to the sulfate form. For example, the chloride form can be soaked in water, and subsequently conditioned with NaOH, water, H₂SO₄, and water.

The following examples further illustrate the invention but, of course, should not be construed as in any way limiting its scope.

### EXAMPLE 1

This example describes of the preparation of chelate-forming beads according to an embodiment of the invention.

2.0 grams of crosslinked beads comprising polymerized vinylbenzylchloride (VBC) and divinylbenzene (DVB) (crosslink level 2 wt. %) were swelled in 50 ml dioxane and transferred into a 250 mL round bottom flask equipped with a condenser and an overhead stirrer. 20 g of NMDG was added to 10 mL of water and 100 mL 1,4-dioxane. The mixture was heated at reflux for 17 hours. After washing, the beads were conditioned with 1 L each of water, 4% aq. NaOH, 4% aq. HCl, and water.

### EXAMPLE 2

This example describes of the preparation of chelate-forming beads according to another embodiment of the invention.

1.5 grams of crosslinked beads comprising polymerized glycidyl methacrylate (GMA) and DVB (crosslink level 8 wt. %) were swelled in 50 ml dioxane and transferred into a 250 mL round bottom flask equipped with a condenser and an overhead stirrer. 10 g of NMDG was added to 10 mL of water and 100 mL 1,4-dioxane. The mixture was heated at reflux for 3 hours. After washing, the beads were conditioned with 1 L each of water, 4% aq. NaOH, 4% aq. HCl, and water.

### EXAMPLE 3

This example demonstrates the swelling ratio of chelate-forming beads according to an embodiment of the invention.

2 mL of the beads described in Example 1 are vacuum dried and placed in a 10 mL cylinder filled with water. After 19 hours, the volume of the beads is 4.6 mL, and thus, the swelling ratio is 2.3.

### EXAMPLE 4

This example demonstrates the volume capacity of chelate-forming beads according to an embodiment of the invention.

Beads are prepared as described in Example 1. Elemental analysis is performed, and combined with the swelling ratio determined as in Example 3, it is determined the beads have a volume capacity of 1.19 mmol Nitrogen/mL.

### EXAMPLE 5

This example demonstrates the selective formation of chelates with As(V) of chelate-forming beads according to an embodiment of the invention as compared to commercially available beads and fibers including NMDG, particularly in the presence of sulfate.

Polymerized VBC-DVB (crosslink level 2 wt. %) beads including NMDG are prepared as described in Example 1. Additionally, the following commercially available beads including NMDG are obtained: Diaion CRB-02 (Mitsubishi Chemical), Purolite S-108 (Purolite Co.), and Amberlite IRA-743 (Rohm and Haas). The following commercially available cotton fibers including NMDG are also obtained: GCP, GRY, and GRY-L (Chelest Corp.). Each set of beads and fibers is placed in contact with As(V) solutions as described below.

The beads and fibers are all conditioned with 1 L each of water, 4% NaOH, water, 4% HCl and water, and vacuum dried at 70° C. Nitrogen elemental analysis is performed on each set of beads and fibers, and beads and fibers containing 0.3 meq of nitrogen are placed in contact with the As(V) solutions.

Two sets of As(V) solutions are prepared using sodium hydrogen arsenate Na₂HAsO₄, 7H₂O (AlfaAesar). The solutions are 20 mL As(V) 100 ppm. One set of As(V) solutions includes a concentration of 560 mg/L SO₄²⁻ (pH 6.0). The set of As(V) solutions without SO₄²⁻ has a pH of 5.8.

Each set of As(V) solutions is placed in contact with a separate set of beads and fibers, i.e., beads prepared in accordance with Example 1 are contacted with the solutions, and each of the commercially available beads and fibers are contacted with the solutions. In placing the As(V) solution in contact with the beads and fibers, 20 mL of the solution is placed in a Nalgene 40 mL bottle containing the beds or fibers, on a shaker. The total contact time is 3 days.

Arsenate concentrations are analyzed by the molybdenum blue method (Charlot) using a spectrophotometer Spectronic 21 D (Milton Roy) equipped with ½″ test tube. For lower concentrations, solutions are analyzed by ICP-MS (Hewlet Packard)

All of the beads and the GRY and GRY-L fibers remove more than 99% (the GCP fibers remove 98.6%) of the arsenic present in solution from the solution without SO₄²⁻. CRB-02 achieves a residual As(V) concentration of 80 ppb, S-108 achieves a residual As(V) concentration of 890 ppb, IRA-743 achieves a residual concentration of 300 ppb, and the VBC-DVB beads prepared in accordance with Example 1 remove 99.9% of the arsenic with a residual As(V) concentration of less than 50 ppb.

The equilibrium solution concentrations (mg/L) and sorption capacities (mg/g) at equilibrium solution concentration are, respectively: 0.03 mg/L and 16.4 mg/g (VBC-2% DVB bead), 0.30 mg/L and 14.7 mg/g (IRA-741), 0.08 mg/L and 14.9 mg/g (CRB-02), 0.89 mg/L and 14.8 mg/g (S-108), 1.42 mg/L and 8.88 mg/g (GCP), 0.04 mg/L and 6.92 mg/g (GRY), and 0.04 mg/L and 7.45 mg/g (GRY-L).

With respect to the As(V) solution including a concentration of 560 mg/L SO₄⁻², the efficiency of removal of As(V) drops for the commercially available beads when compared to the solution without SO₄²⁻, i.e., CRB-02 drops from 99.9% to 90.3%, S-108 drops from 99.1% to 77.9%, and IRA-743 drops from 99.7% to 79.4%. The efficiency of removal for each of the GCP, GRY, and GRY-L fibers is, respectively, 98.8%, 97.8%, and 98.9%.

The equilibrium solution concentrations (mg/L) and sorption capacities (mg/g) at equilibrium solution concentration are, respectively: 20.7 mg/L and 13.3 mg/g (IRA-741), 9.70 mg/L and 13.7 mg/g (CRB-02), 22.2 mg/L and 11.8 mg/g (S-108), 1.21 mg/L and 9.06 mg/g (GCP), 2.22 mg/L and 6.87 mg/g (GRY), and 1.04 mg/L and 7.46 mg/g (GRY-L).

The VBC-2% DVB beads prepared in accordance with Example 1 essentially maintain the removal efficiency and sorption capacity, in that the removal efficiency is 99.4%, and the sorption capacity (at an equilibrium solution concentration of 0.63 mg/L) is 16.6 mg/g.

### EXAMPLE 6

This example describes of the preparation of chelate-forming beads according to another embodiment of the invention, and the selective formation of chelates with As(V) of the chelate-forming beads.

2.0 grams of beads comprising polymerized chloromethylated polystyrene DVB beads (Sybron Chemicals Inc.) (crosslink level 3 wt. %) were swelled in 20 ml dioxane and transferred into a 250 mL round bottom flask equipped with a condenser and an overhead stirrer. 20 g of NMDG was added to 10 mL of water and 100 mL 1,4-dioxane. The mixture was heated at reflux for 17 hours. After washing, the beads were conditioned with 1 L each of water, 4% aq. NaOH, 4% aq. HCl and water.

Nitrogen elemental analysis is performed in accordance with ASTM D 5373 and beads containing 0.3 meq of nitrogen are placed in contact with the As(V) solutions as described in Example 5.

The beads remove 99.9% of the As(V) present in solution from the solution without SO₄²⁻, and achieve a residual As(V) concentration of 65 ppb. The beads remove 96.3% of the As(V) present in solution from the solution with a concentration of 560 mg/L SO₄²⁻.

### EXAMPLE 7

This example describes of the preparation of chelate-forming beads according to another embodiment of the invention.

2.0 grams of beads comprising polymerized VBC and EGDMA (crosslink level 2 wt. %) are swelled and placed in a 250 mL round bottom flask equipped with a condenser and an overhead stirrer. 20 g of NMDG (Arcos Organics) is added to 10 mL of water and 100 mL of dioxane. The mixture is heated at reflux for 17 hours. After washing, the beads are conditioned with 1 L each of water, 1N NaOH, water, 1N HCl, and water, then vacuum dried at 70° C. for 17 hours and characterized by FTIR and nitrogen elemental analysis.

### EXAMPLE 8

This example demonstrates the selective formation of chelates with As(V) using crosslinked beads having the sulfate form of protonated NMDG according to another embodiment of the invention.

Beads are prepared as described in Example 7 to provide beads having the chloride form of protonated NMDG. The beads are treated to exchange the chloride form for the sulfate form by soaking the beads in 1 L of water for 2 hours, followed by conditioning with 1 L of 1N NaOH, 1 L of water, 1 L of 1 N H₂SO₄, and 1 L of water.

Six ml of the beads are arranged in a 1 cm diameter 10 cm long minicolumn, and, in accordance with the ANSI/NSF 53 protocol, challenge water containing 50 ppb As(V), 50 ppm sulfate, 40 ppb phosphate, 2 ppm nitrate, 71 ppm chloride, and 1 ppm fluoride ions is continuously passed through the column. The As(V) concentration in the effluent is consistently reduced below 10 ppb and no breakthrough is observed after 1000 bed volumes.

### EXAMPLE 9

This example describes of the selective formation of chelates with As(V) of chelate-forming beads according to an embodiment of the present invention in the presence of different concentrations of chloride or sulfate ions.

1.6 grams of crosslinked beads comprising VBC and polymerized DVB (crosslink level 2 wt. %) are swelled and placed in a 250 mL round bottom flask equipped with a condenser and overhead stirrer. 20 g of NMDG (Arcos Organics) is added to 10 mL of water, and 100 mL of dioxane. The mixture is refluxed for 17 hours. After washing, the beads are conditioned with 1 L each of water, 1M NaOH, water, 1 M HCl, and water, then vacuum dried at 70° C. for 17 hours and characterized by FTIR and nitrogen elemental analysis.

Additionally, Amberlite IRA-900 beads (Rohm and Haas) are obtained and conditioned and dried as set forth above.

Six sets of As(V) containing solutions are prepared, each containing 100 mg As(V)/L in 0.01, 0.10, and 1.0 M of either Cl⁻ or SO₄²⁻, respectively. 100 mg of each type of dry beads is contacted with 20 mL As(V), 100 mg/L, pH 6.5, at each concentration of either sulfate or chloride ions.

Arsenate is analyzed by the molybdenum blue method using a Spectronic 21D spectrophotometer. At lower concentrations, and in the presence of phosphate, solutions are analyzed by ICP-MS (Hewlett-Packard 4500 series).

At 0.10 M of either Cl⁻ or SO₄²⁻, the beads prepared according to an embodiment of the invention sorb 96% and 83% of the arsenate, respectively, while IRA-900 sorbs less than 10% As(V) in the presence of either competing ion. The trends are identical at all three concentrations. Sulfate ions interfere more than chloride ions. However, with respect to 0.01 M solutions, the effect is much more pronounced with IRA-900 than with the beads prepared according to an embodiment of the invention.

### EXAMPLE 10

This example describes the preparation of chelate-forming beads according to other embodiments of the invention, and the selective formation of chelates with As(V) of the chelate-forming beads as compared to commercially available resins including NMDG, particularly in the presence of sulfate.

1.6 grams of crosslinked beads comprising VBC and polymerized DVB (crosslink levels 2 wt. %, 5 wt. %, 8 wt. %, and 12 wt. %) are swelled and placed in a 250 mL round bottom flask equipped with a condenser and overhead stirrer. 20 g of NMDG (Arcos Organics) is added to 10 mL of water, and 100 mL of dioxane. The mixture is heated at reflux for 17 hours. After washing, the beads are conditioned with 1 L each of water, 1M NaOH, water, 1 M HCl, and water, then vacuum dried at 70° C. for 17 hours and characterized by FTIR and nitrogen elemental analysis.

1.6 grams of 3 wt. % DVB-crosslinked chloromethylated polystyrene beads including NMDG are also prepared as described above.

Additionally, the following commercially available beads including NMDG are obtained as described in Example 5: Purolite S-108, Diaion CRB-02, and Amberlite IRA-743.

Beads containing 0.3 mmol of nitrogen are placed in contact with the As(V) solutions for 21 hours.

Two sets of As(V) solutions are prepared. One solution is 20 mL As(V), 100 mg/L, pH 6. The other solution is 20 mL As(V), 100 mg/L+560 mg/L SO₄²⁻, pH 6.

Each set of As(V) solutions is placed in contact with a separate set of beads, i.e. NMDG beads prepared as described above at each crosslink density are contacted with the solutions, CRB-02 beads are contacted with the solutions, S-108 beads are contacted with the solutions, and IRA-743 beads are contacted with the solutions.

Arsenate is analyzed by the molybdenum blue method using a Spectronic 21D spectrophotometer. At lower concentrations, solutions are analyzed by ICP-MS (Hewlett-Packard 4500 series).

With the exception of the 12 wt. % DVB-VBC NMDG beads, all of the beads remove more than 99% of the arsenate present in solution from the solution without SO₄²⁻. The 12% DVB-VBC NMDG beads remove about 95% of the arsenate present in solution from the solution without SO₄²⁻.

With respect to the As(V) solution including a concentration of 560 mg/L SO₄⁻², the efficiency of removal of As(V) drops for the commercially available beads when compared to the solution without SO₄²⁻, i.e., CRB-02 drops to about 73%, S-108 drops to about 50%, and IRA-743 drops to about 55%.

With the exception of the 8 wt. % and 12 wt. % DVB-VBC NMDG beads, all of the other prepared non-commercially available crosslinked NMDG beads (having 2%, 3%, and 5% crosslinking levels) remove over 90% of the arsenate present in solution from the solution with SO₄²⁻. The 8 wt. % and 12 wt. % DVB-VBC NMDG beads remove about 55% and about 40%, respectively, of the arsenate present in solution from the solution with SO₄²⁻.

### EXAMPLE 11

This example describes of the higher nitrogen content by dry weight basis of the chelate-forming beads according to other embodiments of the invention as compared to three commercially available products.

Crosslinked beads comprising polymerized VBC and DVB (crosslink levels 2 wt. %, 5 wt. %, 8 wt. %, and 12 wt. %) including NMDG are prepared as described in Example 10. Crosslinked beads comprising polymerized VBC crosslinked with EGDMA (crosslink levels 2% and 4%) including NMDG are prepared as described in Example 7.

The following commercially available beads including NMDG are also obtained: Amberlite IRA-743, Diaion CRB-02, and Purolite S-108.

Nitrogen elemental analysis of the beads is performed in accordance with ASTM D 5373.

The results are as follows:

| Bead including NMDG | Nitrogen content (mmol/g) |
|---|---|
| 2% DVB gel polyVBC | 2.62 |
| 3% DVB gel chloromethylated | 2.68 |
| polystyrene | |
| 5% DVB macroporous polyVBC | 2.58 |
| 8% DVB macroporous polyVBC | 2.21 |
| 12% DVB macroporous polyVBC | 1.81 |
| 2% EGDMA polyVBC | 2.69 |
| 4% EGDMA polyVBC | 2.58 |
| IRA-743 | 2.24 |
| CRB-02 | 2.26 |
| S-108 | 2.27 |

The table shows that, when analyzed in accordance with ASTM D 5373, prepared beads having less than 8% crosslinking have a nitrogen content by dry weight basis of greater than 2.35 mmol/g, and commercially available beads have a nitrogen content by dry weight basis of 2.27 mmol/g or less.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value failing within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chelate-forming material comprising:
a crosslinked polymeric bead having bound chelate-forming groups and a volume capacity of about 1.5 mmol/mL or less, wherein the chelate-forming groups comprise protonated N-methyl-D-glucamine, and have the capability of forming a chelate with As(V) and/or compounds thereof.

2. The chelate-forming material of claim 1, wherein the crosslinked polymeric bead has a volume capacity of about 1.3 mmol/mL or less.

3. The chelate-forming material of claim 1, wherein the crosslinked polymeric bead comprises poly(vinylbenzylchloride).

4. The chelate-forming material of claim 1, wherein the crosslinked polymeric bead comprises chloromethylated polystyrene.

5. The chelate-forming material of claim 1, wherein the crosslinked polymeric bead comprises a polymerized bi-, tri-, or tetra-functional monomer, or any combination thereof.

6. The chelate-forming material of claim 5, wherein the bi-, tri-, or tetra-functional monomer is selected from the group consisting of ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, butanediol diacrylate, hexanediol diacrylate, N,N-methylenebisacrylamide, N,N-(1,2-dihydroxyethylene) bisacrylamide, and divinylbenzene, or any combination thereof.

7. The chelate-forming material of claim 1, wherein the protonated N-methyl-D-glucamine is in chloride form.

8. The chelate-forming material of claim 1, wherein the protonated N-methyl-D-glucamine is in sulfate form.

9. The chelate-forming material of claim 1, wherein the crosslinked polymer bead has a nitrogen content on a dry weight basis of about 2.4 mmol/gm or more.

10. The chelate-forming material of claim 9, wherein the crosslinked polymer bead has a nitrogen content on a dry weight basis of about 2.5 mmol/gm or more.

11. The chelate-forming material of claim 1, wherein the crosslinked polymer bead has a crosslinking ratio in the range of from about 2% to about 5%.

12. The chelate forming material of claim 11, wherein the bead is prepared using divinylbenzene or ethylene glycol dimethacrylate as a crosslinking agent.

13. The chelate-forming material of claim 1, wherein the crosslinked polymer bead has a crosslinking ratio in the range of from about 2% to about 7%.

14. The chelate forming material of claim 13, wherein the bead is prepared using ethylene glycol dimethacrylate as a crosslinking agent.

15. A chelate-forming material comprising:
a crosslinked polymeric bead having bound chelate-forming groups and a nitrogen content on a dry weight basis of about 2.4 mmol or more, wherein the chelate-forming groups comprise protonated N-methyl-D-glucamine and have the capability of forming a chelate with As(V) and/or compounds thereof.

16. A method for treating an arsenic-containing aqueous fluid comprising:
contacting an As(V)-containing aqueous fluid with crosslinked polymeric beads each having bound chelate-forming groups, and a volume capacity of about 1.5 mmol/mL or less and/or a nitrogen content on a dry weight basis of about 2.4 mmol/g or more, wherein the chelate-forming groups comprise protonated N-methyl-D-glucamine and have the capability of forming a chelate with As(V) and/or compounds thereof;
forming the chelate with As(V) and/or a compound thereof; and
separating the chelated As(V) and/or compound thereof from the fluid.

17. The method of claim 16, wherein the crosslinked polymeric beads each have a volume capacity of about 1.3 mmol/mL or less.

18. The method of claim 16, wherein the crosslinked polymeric beads each have a nitrogen content on a dry weight basis of about 2.5 mmol/gm or more.

19. The method of claim 16, wherein the crosslinked polymeric beads comprise poly(vinylbenzylchloride).

20. The method of claim 16, wherein the crosslinked polymeric beads comprise poly(glycidyl methacrylate).

21. The method of claim 16, wherein the crosslinked polymeric beads comprise chloromethylated styrene.

22. The method of claim 16 wherein the crosslinked polymeric bead comprises a polymerized bi-, tri-, or tetra-functional monomer, or any combination thereof.

23. The method of claim 22, wherein the bi-, tri-, or tetra-functional monomer is selected from the group consisting of ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, butanediol diacrylate, hexanediol diacrylate, N,N-methylenebisacrylamide, N,N-(1,2-dihydroxyethylene) bisacrylamide, and divinylbenzene, or any combination thereof.

24. The method of claim 16, wherein the protonated N-methyl-D-glucamine is in chloride form.

25. The method of claim 16, wherein the protonated N-methyl-D-glucamine is in sulfate form.

26. The method of claim 16, wherein the arsenic-containing aqueous fluid is groundwater.

27. A process for preparing a chelate-forming crosslinked polymeric bead having a volume capacity of about 1.5 mmol/mL or less and/or a nitrogen content on a dry weight basis of about 2.4 mmol/g or more, wherein the bead is comprised of a crosslinked polymer bound to chelate-forming groups, comprising;
obtaining a crosslinked polymeric bead having functional groups;
reacting the functional groups with N-methyl-D-glucamine; and
producing a protonated N-methyl-D-glucamine.

28. The process of claim 27, wherein the chelate-forming crosslinked polymeric bead has a volume capacity of about 1.3 mmol/mL or less.

29. The process of claim 27, wherein the crosslinked polymeric bead comprises a poly(vinylbenzylchloride) bead.

30. The process of claim 27, wherein the crosslinked polymeric bead comprises a poly(glycidyl methacrylate) bead.

31. The process of claim 27, wherein the crosslinked polymeric bead comprises a chloromethylated polystyrene bead.

32. The process of claim 27, wherein the functional groups on the crosslinked polymer bead are haloalkyl groups.

33. The process of claim 27, wherein the functional groups on the crosslinked polymer beads are epoxy groups.

34. The process of claim 27, comprising producing a chloride form of protonated N-methyl-D-glucamine.

35. The process of claim 27, comprising producing a sulfate form of protonated N-methyl-D-glucamine.

36. A bead produced by the process of claim 27.

37. A system for treating arsenic-containing aqueous fluid comprising:
a bed comprising crosslinked polymeric beads each bead having bound chelate-forming groups, and a volume capacity of about 1.5 mmol/mL or less and/or a nitrogen content on a dry weight basis of about 2.4 mmol/g or more, wherein the chelate-forming groups comprise protonated N-methyl-D-glucamine, and have the capability of forming a chelate with As(V) and/or compounds thereof.

38. The chelate-forming material of claim 1, wherein the crosslinked polymeric bead comprises poly(glycidyl methacrylate).
